(19) United States
(12) Patent Application Publication
(10) Pub. No.: US 2016/0073294 A1
(43) Pub. Date: Mar. 10, 2016

(54) PROVIDING WIFI RADIO AVAILABILITY INFORMATION

(71) Applicant: NOKIA TECHNOLOGIES OY, Espoo (FI)

(72) Inventors: Carl WIJTING, Espoo (FI); Antti SORRI, Helsinki (FI); Zexian LI, Espoo (FI); Jarkko KOSKELA, Oulu (FI); Jussi-Pekka KOSKINEN, Oulu (FI); Ilkka KESKITALO, Oulu (FI); Sari NIELSEN, Espoo (FI); Lars DALSGAARD, OULU (FI); Antti PIIPPONEN, Vantaa (FI)

(21) Appl. No.: 14/782,716

(22) PCT Filed: Apr. 14, 2014
(86) PCT No.: PCT/FI2014/050268

§ 371 Date: Oct. 6, 2015

Related U.S. Application Data
(60) Provisional application No. 61/812,430, filed on Apr. 16, 2013.

(51) Int. Cl. H04W 28/08; H04W 76/02; H04W 28/02; H04W 48/18

(52) U.S. Cl. CPC H04W 28/08; H04W 48/18; H04W 76/02; H04W 28/0236; H04W 84/12

(57) ABSTRACT

Certain embodiments generally relate to WiFi radio availability information, such as, but not limited to methods, apparatuses, and systems for providing WiFi radio availability information for WLAN (Wireless Local Area Network)/3GPP (Third Generation Partnership Project) radio interworking purposes. For example, the method may include determining an availability of a non-cellular access, which is interworking with a cellular access, for an user equipment. The method may also include deciding whether to off-load at least part of the traffic of the user equipment to the non-cellular access based at least in part on the determined availability.

### CROSS-REFERENCE TO RELATED APPLICATION

This application is related to and claims the priority of U.S. Provisional Patent Application No. 61/812,430, which was filed Apr. 16, 2013, and which is hereby incorporated herein by reference in its entirety.

### BACKGROUND

1. Field

Various communication systems may benefit from methods and apparatuses for providing WiFi radio availability information for WLAN (Wireless Local Area Network)/3GPP (Third Generation Partnership Project) radio interworking purposes. For example, a UE (User Equipment) may benefit from such WiFi radio availability information and may be able to use such information to realize specified levels of performance.

2. Description of the Related Art

There is no standardized interface between WLAN APs (Access Points) and LTE (Long Term Evolution) eNBs (evolved Node B). Therefore, the role of a UE in the process of network selection may become important in order to provide radio level information for interworking decision making.

Considering today's deployment scenarios, the UE may prefer to get a WLAN connection from a third party WLAN network, instead of from an operator's WLAN network. For example, when at the office, there may be a corporate WLAN network, and most of the UEs, if not all, may try to connect to this corporate WLAN for better service. A similar situation may exist when users are on their home WLAN. Due to radio capability limitations, such as there being only one WLAN transceiver within the device, offloading to an operator WLAN may conflict with an existing connection to a home or corporate WLAN.

### SUMMARY

Various aspects of examples of the invention are set out in the claims.

According to a first aspect of the present invention, a method, comprising: determining an availability of a non-cellular access, which is interworking with a cellular access, for an user equipment; and deciding whether to off-load at least part of the traffic of the user equipment to the non-cellular access based at least in part on the determined availability, is disclosed.

According to a second aspect of the present invention, an apparatus, comprising: at least one processor; and at least one memory including computer program code, wherein the at least one memory and the computer program code are configured to, with the at least one processor, cause the apparatus at least to: determine an availability of a non-cellular access, which is interworking with a cellular access, for an user equipment; and decide whether to off-load at least part of the traffic of the user equipment to the non-cellular access based at least in part on the determined availability, is disclosed.

According to a third aspect of the present invention, an apparatus, comprising: determining means for determining an availability of a non-cellular access, which is interworking with a cellular access, for an user equipment; and deciding means for deciding whether to off-load at least part of the traffic of the user equipment to the non-cellular access based at least in part on the determined availability, is disclosed.

### BRIEF DESCRIPTION OF THE DRAWINGS

For proper understanding of the invention, reference should be made to the accompanying drawings, wherein:

FIGS. 1A-E illustrates signaling flow diagrams according to certain embodiments.

FIG. 2 illustrates a flow diagram according to certain embodiments.

FIG. 3 illustrates a block diagram of a system according to certain embodiments.

### DETAILED DESCRIPTION:

Certain embodiments provide techniques and apparatuses for providing WiFi radio availability information for WLAN (Wireless Local Area Network)/3GPP (Third Generation Partnership Project) radio interworking purposes. Moreover, such embodiments may help a UE (User Equipment) to use such information to realize specified levels of performance by introducing signaling of the information that is exchanged or transmitted between the network and a UE to indicate the availability of the WLAN radio for operator-controlled WLAN/3GPP interworking in different scenarios. Thus, certain embodiments provide a way for a UE, which may contain both a WLAN and a cellular radio, for example, LTE, to inform an LTE network as to whether or not offloading to an operator WLAN is possible. Thus, certain embodiments may provide an improved end-user experience.

In certain embodiments, a method, apparatus, and/or system may determine whether the WLAN transmitter/receiver in the UE is available for the operator-controlled WLAN/3GPP interworking. This determination may be based on UE mobility/speed, that is, if the UE is moving WLAN could be signaled as not available. This determination may also be based on other than operator controlled WLAN connection ongoing, that is, if another WLAN session ongoing operator-controlled WLAN would not be available. This determination may further be based on if the UE has detected WLAN AP belonging to the operator-controlled WLAN network. This determination may still further be based on if the UE is able to connect/register WLAN AP belonging to the operator controlled WLAN network or the UE battery state, for example, it may not be desirable to run WLAN in parallel while in a low battery state. This determination may also be based on network congestion or radio parameters on WLAN side, RSSI (Radio Signal Strength Indication), load information from the WLAN network (e.g. number of associated WLAN stations, backhaul load) or the like. This determination may further be based on a specific service used either on LTE or WLAN side, for example, VPN (Virtual Private Network) connection which cannot be migrated without breaking the connection. Further, this determination may include any combination of above basis.

In certain embodiments, the signaling of the information may, for example be implemented as RRC (Radio Resource Control) signaling. A new UE radio capability parameter, which may be called “Support for WLAN,” related to support for WLAN in a UE may be used when configuring services for devices.

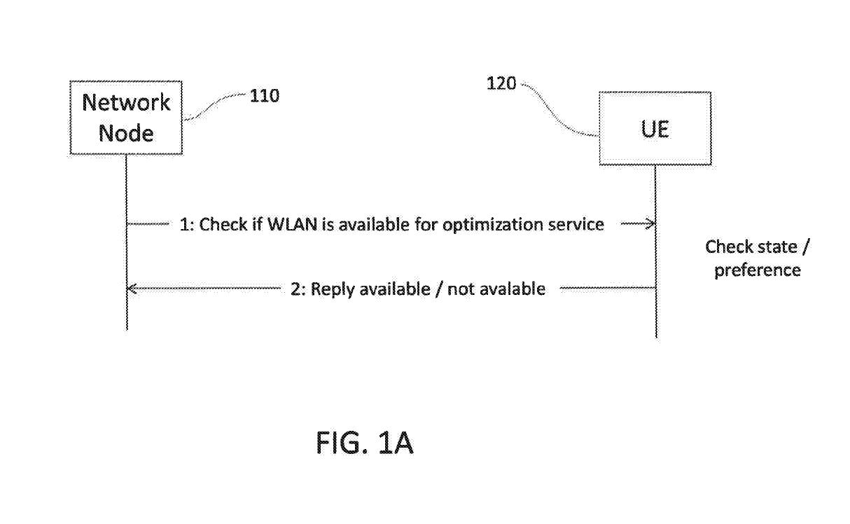

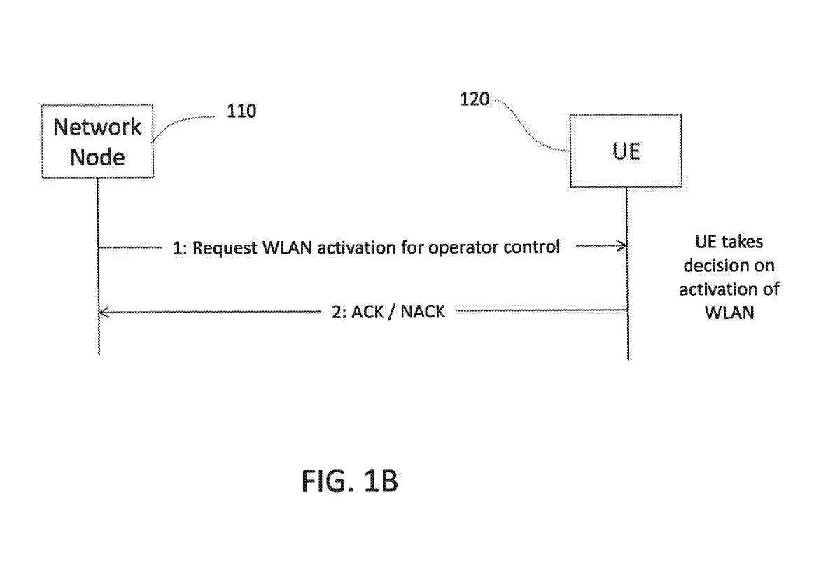

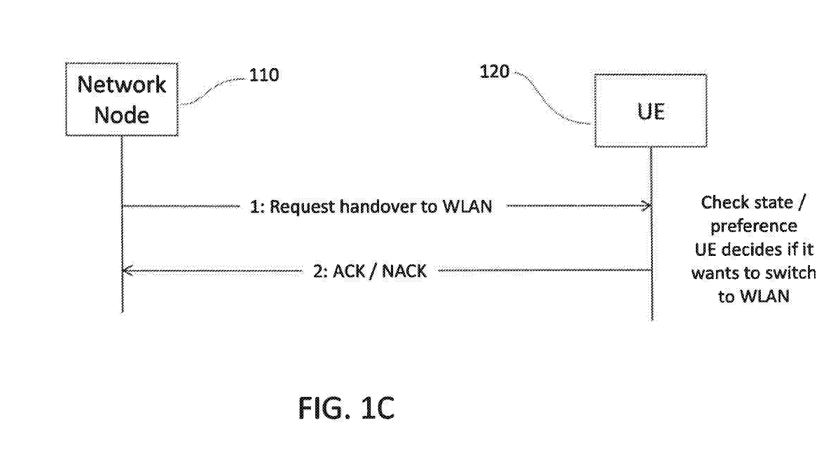

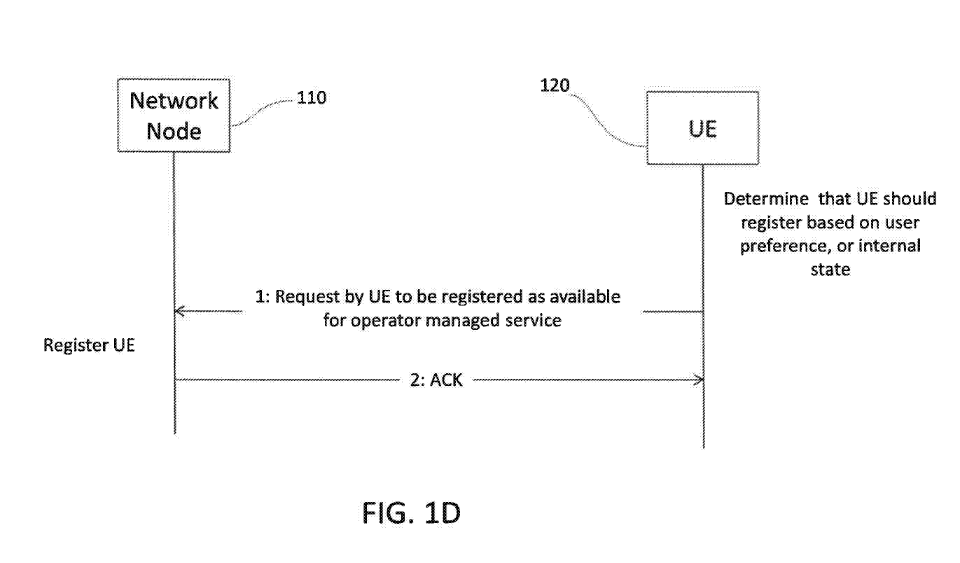

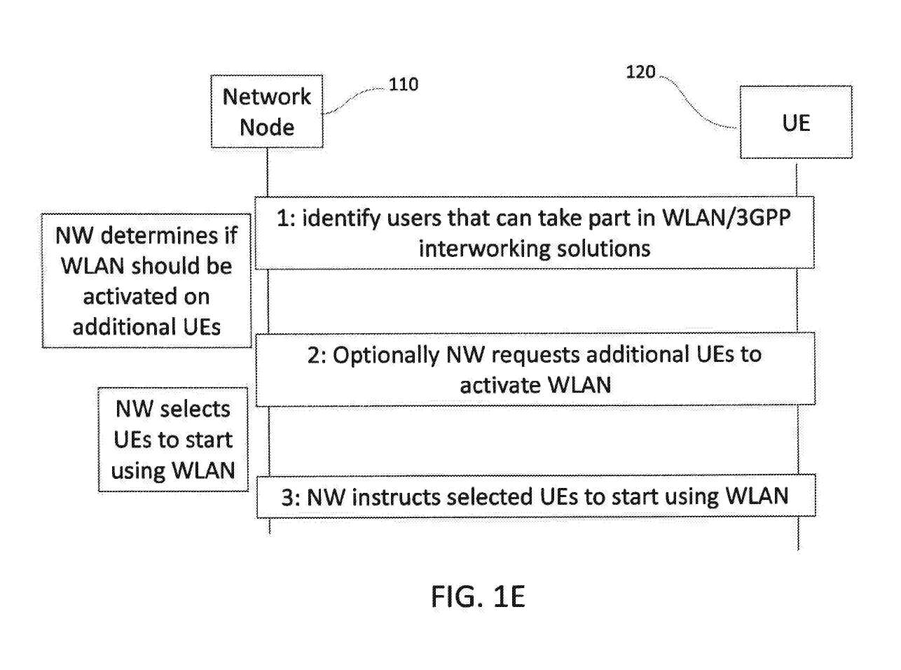

FIGS. 1A-E illustrates signaling flow diagrams according to certain embodiments. In FIGS. 1A-E, the exchange of the information may be initiated/triggered by either the terminal/user equipment 120 or the network node 110. Such a configuration may enable both a mode where the network node 110 requests the status of one or multiple UEs (120) so that it may initiate the use of optimization services for relevant devices, and a mode where the UE 120 registers to the operator an optimized solution. The optimization service could, for example, be configured such that the operator optimizes the usage of the capacity in a heterogeneous network (not shown) with both LTE capacity and WLAN capacity for UEs (120) that also can/want to use WLAN networks. In another example, the optimization service would include the case where there may be a mix of UEs, some with LTE only and some with LTE+WiFi. The network could also optimize the performance in this case, but only the WiFi capable UEs may be offloaded to WLAN.

In certain embodiments network node 110 may identify a UE 120 that wants to be part of an optimized service. For illustration purposes one UE is shown in FIGS. 1A-E, however, UE 120 may be representative of a plurality of UEs. In such a network, a network query for WLAN availability may be performed. For instance in FIG. 1A network node 110 may be configured to send a signal to UE 120 to check if WLAN is available for optimization service (at Message-1). Next UE 120 may check state/preference and then may reply either available or not available to network node 110 (at Message-2).

In other embodiments a network request for WLAN activation may be performed. For instance, in FIG. 1B network node 110 may be configured to send a signal to UE 120 to request WLAN switch on for optimization service (at Message-1). Next UE 120 may make a final decision on activation of WLAN. Based on the outcome, UE 120 may send either an ACK or NACK to network node 110 (at Message-2).

In some embodiments, a network initiated switch to WLAN may be performed. For instance, in FIG. 1C network node 110 may be configured to send a signal to UE 120 to request to handover (HO) to WLAN (at Message-1). Next UE 120 may check state/preference and decide if it wants to switch to WLAN. Based on such a decision by UE 120, UE 120 may send either an ACK or NACK to network node 110 (at Message-2).

In other embodiments, UE originated registration for operator managed operation may be performed. For instance, in FIG. 1D network node 110 may be configured to receive a signal from UE 120 to request UE 120 to be registered as available to network node 110 for operator managed service (at Message-1). The UEs (120) may identify which UE to register as available based on user preference or internal state. Next, network node 110 may send an ACK signal to UE 120 that UE 120 is registered as available (at Message-2).

In certain embodiments, an operator optimization service for WLAN/3GPP network based on the above options could look as follows. Network node 110 may identify users that may be part ofthe optimization service (using FIG. 1A or using FIG. 1D configurations).

In other embodiments, an operator optimization service for WLAN/3GPP network based on the above options could look as follows. If needed, network node 110 may ensure that WLAN is activated (using FIG. 1B configuration).

In some embodiments, an operator optimization service for WLAN/3GPP network based on the above options could look as follows. Network node 110 may select UEs (120) for handover to WLAN, for example by selecting only UEs (120) which have acknowledged that WLAN radio is on.

In certain embodiments, an operator optimization service for WLAN/3GPP network based on the above options could look as follows. Network node 110 may issue instructions to handover (using FIG. 1C configuration).

Alternatively, in the optimization service different message exchanges (signals) as described above may be combined in the same message as well as requested separately. In other words, the optimization service may comprise some or all of the message steps shown in FIGS. 1A-D.

In FIG. 1E, according to certain embodiments, network node 110 determines if WLAN should be activated on additional UEs (120) by identifying users that can take part in WLAN/3GPP interworking solutions (at Message-1). This identification may be done, for example, by performing a network query or UE 120 registration. Optionally, network node 110 may request additional UEs (120) to activate WLAN (at Message-2). Network node 110 may select UEs (120) to start using WLAN. Next, network node 110 may instruct the selected UEs (120) to starting using WLAN (at Message-3).

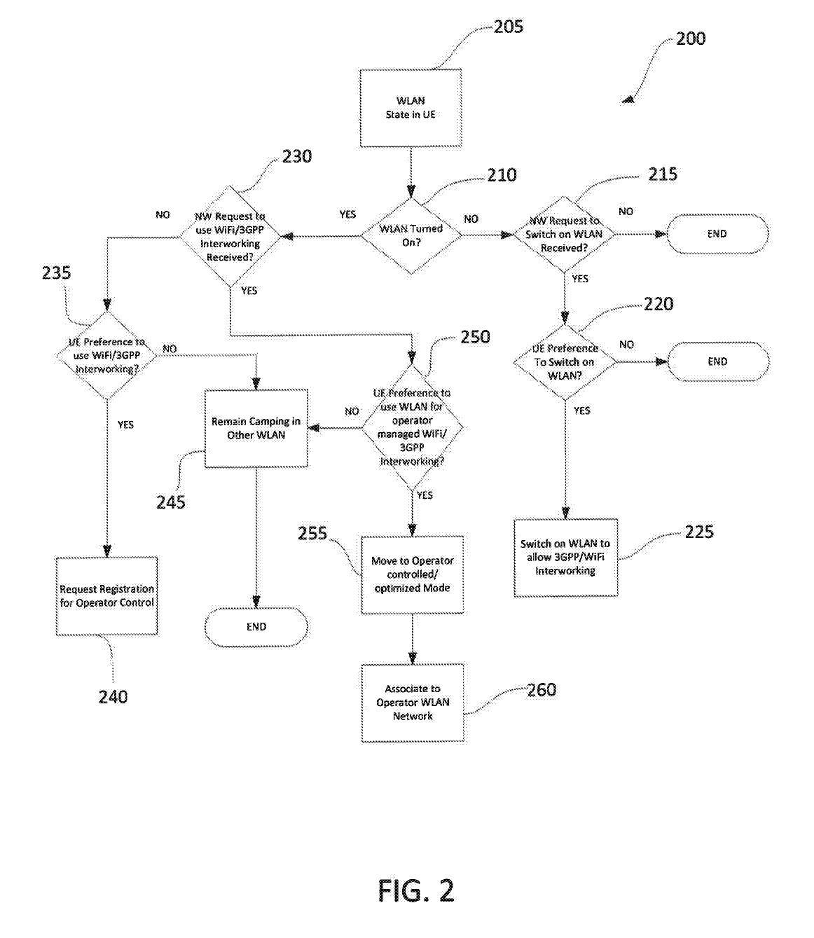

In certain embodiments, the availability of the WLAN radio may be determined based on an analysis of the current and expected use of the WLAN radio in UE 120. FIG. 2 illustrates a flow diagram 200 according to certain embodiments illustrating such an analysis. Internal states at UE 120 side that may be used for this technique may include, for example at 205, 210, determining the WLAN state in UE 120. If the WLAN is not turned on then network node 110 may, for example at 215, request to switch on WLAN. If UE 120 receives such a request, UE 120 may have a preference to switch on WLAN, for example at 220, resulting in switching on WLAN to allow 3GPP/WiFi interworking, for example at 225.

Other internal states at UE 120 side that may be used include, for example, if the WLAN is turned on then network node 110 may, for example at 230, request to use WiFi/3GPP interworking. If UE 120 does not receive such a request from network node 110, then UE 120 may have a preference to use WiFi/3GPP interworking and then request registration for operator control, for example at 235, 240. Otherwise, UE 120 may not have a preference to use WiFi/3GPP interworking and therefore UE 120 may remain camping in other WLAN, for example at 245. However, if UE 120 does receive the request to use WiFi/3GPP interworking from network node 110, then UE 120 may have a preference whether to use WLAN for operator managed WiFi/3GPP interworking, for example at 250. If UE 120 uses such a preference as shown at 250, then UE 120 may move to operator controller/optimized mode and associate to an operator WLAN network, for example at 255, 260. Otherwise, UE 120 may not have a preference to use WLAN for operator managed WiFi/3GPP interworking which may result in UE 120 remaining camped in other WLAN, for example at 245.

In some embodiments a new UE radio capability parameter related to support for WLAN in a UE may be used when configuring services for devices. This parameter may determine whether or not WLAN connectivity is supported, and, if so, whether WLAN is available for operator control. Alternatively, this parameter may include details obtained about the WLAN connectivity, for example, supported version, available data rate, or the like.

Referring back to FIGS. 1A-E, signaling may be introduced to exchange the WLAN state information so that the WLAN/3GPP interworking performance may be optimized. The signaling may be lightweight allowing for dynamic operation.

There may be cases where a WLAN home network may not be available for operator control. These cases may include: home environment, office environment, device to device (D2D) service, wireless display, UE in high mobility state, and user preference indication. However, the availability to access these cases could, for instance be determined from the connectivity settings (similar to MS WINDOWS® settings such as connected to public network, home network, or the like.) or by specific user settings in a user preference profile.

Furthermore, UE may not be willing to move to the operator managed network, preferring some alternative.

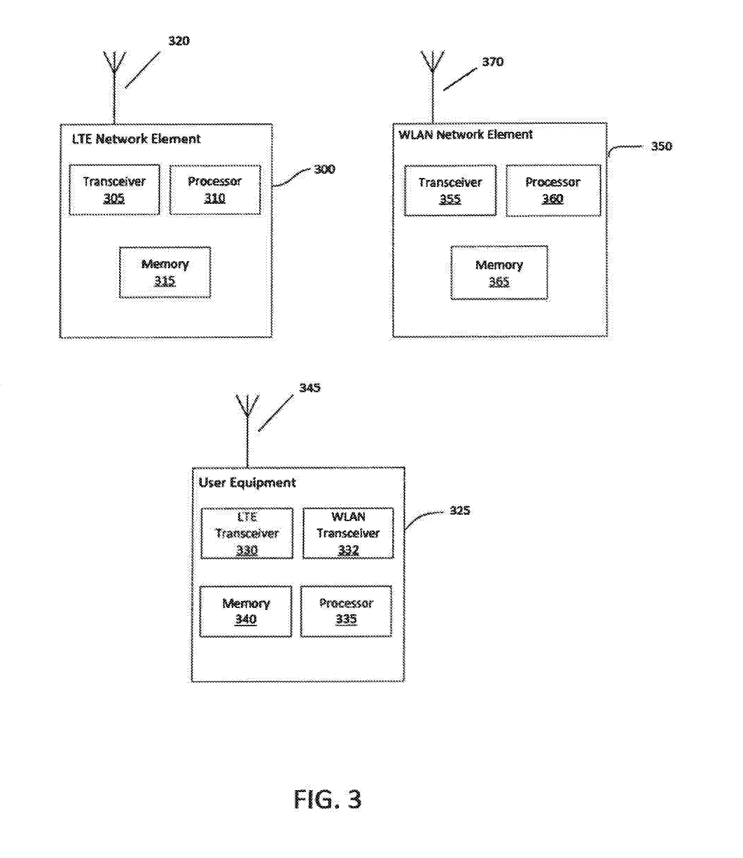

FIG. 3 illustrates a block diagram of a system according to certain embodiments. In one embodiment, a system may comprise several devices, such as, for example, LTE network element 300, user equipment 325, and WLAN network element 350. LTE network element 300 may correspond to network node 110, shown in FIGS. 1A-E. The system may comprise more than network element, user equipment, or WLAN, although only one of each is shown for the purposes of illustration. LTE network element 300 may be an eNodeB. User equipment 325 may be any Internet-connected device, such as a tablet computer, mobile phone, smart phone, laptop computer, personal digital assistant (PDA) or the like. WLAN network element 350 may be a small cell, such as a picocell, femtocell, or the like.

Each of the devices in the system may comprise at least one processor, respectively indicated as 310, 335, and 360. At least one memory may be provided in each device, and indicated as 315, 340, and 365, respectively. The memory may comprise computer program instructions or computer code contained therein. One or more transceiver 305, 330, 332, and 355 may be provided, and each device may also comprise an antenna, respectively illustrated as 320, 345, and 370. Although only one antenna each is shown, many antennas and multiple antenna elements may be provided to each of the devices. Other configurations of these devices, for example, may be provided. For example, LTE network element 300, user equipment 325, and WLAN network element 350 may be additionally or solely configured for wired communication and in such a case antennas 320, 345, and 370 may illustrate any form of communication hardware, without being limited to merely an antenna.

Transceivers 305, 330, 332, and 355 may each, independently, be a transmitter, a receiver, or both a transmitter and a receiver, or a unit or device that may be configured both for transmission and reception. User equipment 325 may include, for example, LTE transceiver 330 as well as WLAN transceiver 332 in certain embodiments.

Processors 310, 335, and 360 may be embodied by any computational or data processing device, such as a central processing unit (CPU), application specific integrated circuit (ASIC), or comparable device. The processors may be implemented as a single controller, or a plurality of controllers or processors.

Memories 315, 340, and 365 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and may be processed by the processors may be any suitable form of computer program code, for example, a compiled or interpreted computer program written in any suitable programming language.

The memory and the computer program instructions may be configured, with the processor for the particular device, to cause a hardware apparatus such as LTE network element 300, user equipment 325, and WLAN network element 350, to perform any of the processes described above. Therefore, in certain embodiments, a non-transitory computer-readable medium may be encoded with computer instructions that, when executed in hardware, may perform a process, such as one of the processes described herein. Alternatively, certain embodiments of the invention may be performed entirely in hardware.

The various example embodiments described above allow the UE to be an interconnection point in an interworking solution. These example embodiments provide a suitable wireless connectivity and thus a better user experience to the end users. These example embodiments also allow networks and operators to obtain knowledge of the states and preferences of the UE or even “dynamic” capability for operator-controlled WLAN support and IW enhancements. This information may allow optimizations in the network implementations and algorithms used in 3GPP-WLAN radio interworking. For instance, these techniques may allow operators to obtain a more realistic estimate for network load balancing impacts and benefits when only the traffic of the UEs, which may be moved from 3GPP radio network to WLAN, are considered in load balancing algorithms instead of the data traffic of all UEs connected to 3GPP radio network.

A method in certain embodiments may include determining a condition of a user equipment. The method may also include signaling availability for off-loading the user equipment to non-cellular access based on the determined condition.

In a variation the determining may comprise determining based on UE mobility/speed. The determining may also comprise determining based on other than operator-controlled WLAN connection ongoing. The determining may also comprise determining based on if the UE has detected WLAN AP belonging to the operator-controlled WLAN network. The determining may also comprise determining based on if the UE is able to connect/register WLAN AP belonging to the operator controlled WLAN network or the UE battery state. The determining may also comprise determining based on network congestion or radio parameters on WLAN side, RSSI (Radio Signal Strength Indication). The determining may also comprise determining based on a specific service used either on LTE or WLAN side, for example, VPN (Virtual Private Network) connection which cannot be migrated without breaking the connection. The determining may also comprise determining based on any combination of the above.

In a variation the signaling comprises signaling the availability in a radio capability parameter.

In other embodiments an apparatus may include at least one processor and at least one memory including computer program code. The at least one memory and the computer program code may be configured to, with the at least one processor, cause the apparatus at least to determine a condition of a user equipment. The computer program code may be configured to, with the at least one processor, cause the apparatus at least to signal availability for off-loading the user equipment to non-cellular access based on the determined condition.

An apparatus, in certain embodiments, comprises determining means for determining a condition of a user equipment. The apparatus may also include signaling means for signaling availability for off-loading the user equipment to non-cellular access based on the determined condition.

A non-transitory computer-readable medium in certain embodiments is encoded with instructions that, when executed in hardware, perform a process. The process may include determining a condition of a user equipment. The process may also include signaling availability for off-loading the user equipment to non-cellular access based on the determined condition.

A method in certain embodiments may include receiving a signal indicating an availability of a user equipment to be offloaded to non-cellular access. The method may also include determining whether to off-load the user equipment to the non-cellular access based on the availability.

In other embodiments an apparatus may include at least one processor and at least one memory including computer program code. The at least one memory and the computer program code may be configured to, with the at least one processor, cause the apparatus at least to receive a signal indicating an availability of a user equipment to be offloaded to non-cellular access. The at least one memory and the computer program code may be configured to, with the at least one processor, cause the apparatus at least to determine whether to off-load the user equipment to the non-cellular access based on the availability.

An apparatus in certain embodiments may include receiving means for receiving a signal indicating an availability of a user equipment to be offloaded to non-cellular access. The apparatus may also include determining means for determining whether to off-load the user equipment to the non-cellular access based on the availability.

A non-transitory computer-readable medium in certain embodiments is encoded with instructions that, when executed in hardware, perform a process. The process may include receiving a signal indicating an availability of a user equipment to be offloaded to non-cellular access. The process may also include determining whether to off-load the user equipment to the non-cellular access based on the availability.

A system, according to certain embodiments, may include a first apparatus and a second apparatus. The first apparatus may include determining means for determining a condition of a user equipment and signaling means for signaling availability for off-loading the user equipment to non-cellular access based on the determined condition. The second apparatus may include receiving means for receiving the signal and determining means for determining whether to off-load the user equipment to the non-cellular access based on the availability.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS AND DEFINITIONS

3GPP Third Generation Partnership Project

eNB evolved Node B, a base station in LTE

LTE Long Term Evolution of 3GPP

UE User Equipment

WLAN Wireless Local Area Network

1-26. (canceled)

27. A method, comprising:
determining an availability of a non-cellular access, which is interworking with a cellular access, for an user equipment;
deciding whether to off-load at least part of traffic of the user equipment to the non-cellular access based at least in part on the determined availability; and
transmitting a signal indicating the determined availability of the non-cellular access.

28. The method according to claim 27, wherein the off-loading comprises at least one of selecting a non-cellular access network and steering traffic to a non-cellular access network.

29. The method according to claim 27, further comprising: receiving, at the user equipment, a request for the availability indication; or sending, by a base station, a request for the availability indication.

30. The method according to claim 27, further comprising: initiating the off-loading to the non-cellular access.

31. The method according to claim 27, wherein the determining is based on a predetermined service used either by a base station or a small cell.

32. The method according to claim 27, wherein the availability is determined based on at least one of whether other than operator controlled wireless local area network (WLAN) connection is ongoing and whether a virtual private network (VPN) connection is ongoing or not.

33. The method according to claim 27, wherein the availability is determined based on at least one of user equipment capability, congestion in the non-cellular access, radio parameters of a non-cellular access network, signal strength of a non-cellular access network, load information of a non-cellular access network, and speed of the user equipment.

34. The method according to claim 27, wherein the method is performed by either a base station or a user equipment.

35. An apparatus, comprising:
at least one processor; and
at least one memory including computer program code,
wherein the at least one memory and the computer program code are configured to, with the at least one processor, cause the apparatus at least to:
determine an availability of a non-cellular access, which is interworking with a cellular access, for an user equipment;
decide whether to off-load at least part of traffic of the user equipment to the non-cellular access based at least in part on the determined availability; and
transmit a signal indicating the determined availability of the non-cellular access.

36. The apparatus according to claim 35, wherein the off-loading comprises at least one of selecting a non-cellular access network and steering traffic to a non-cellular access network.

37. The apparatus according to claim 35, the at least one memory and the computer program code are configured to, with the at least one processor, cause the apparatus at least to initiate the off-loading to the non-cellular access.

38. The apparatus according to claim 35, the at least one memory and the computer program code are configured to, with the at least one processor, cause the apparatus at least to send a signal initiating a switch to the non-cellular access.

39. The apparatus according to claim 35, the at least one memory and the computer program code are configured to, with the at least one processor, cause the apparatus at least to initiate a non-cellular access switch at the user equipment.

40. The apparatus according to claim 35, wherein the signal indicating the availability of the non-cellular access comprises signaling the availability in a radio capability parameter.

41. The apparatus according to claim 35, the at least one memory and the computer program code are configured to, with the at least one processor, cause the apparatus at least to receive, at the user equipment, a request for the availability indication; or send, by a base station, a request for the availability indication.

42. The apparatus according to claim 35, wherein the determining is based on a predetermined service used either by a base station or a small cell.

43. The apparatus according to claim 35, wherein the availability is determined based on at least one of whether other than operator controlled wireless local area network (WLAN) connection is ongoing and whether a virtual private network (VPN) connection is ongoing or not.

44. The apparatus according to claim 35, wherein the availability is determined based on at least one of user equipment capability, congestion in the non-cellular access, radio parameters of a non-cellular access network, signal strength of a non-cellular access network, load information of a non-cellular access network, and speed of the user equipment.

45. The apparatus according to claim 44, wherein the load information of the non-cellular access comprises at least one of the number of associated stations in the non-cellular access and backhaul load.

46. The apparatus according to claim 36, wherein the apparatus is at least part of either a base station or a user equipment.
